(19) United States
(12) Patent Application Publication
(10) Pub. No.: US 2017/0143012 A1
(43) Pub. Date: May 25, 2017

(54) NATURAL SWEETENED COMPOSITIONS AND METHODS FOR PREPARING THE SAME

(71) Applicant: The Coca-Cola Company, Atlanta, GA (US)

(72) Inventors: Rafael I. San Miguel, Smyrna, GA (US); Indra Prakash, Alpharetta, GA (US)

(21) Appl. No.: 15/381,802

(22) Filed: Dec. 16, 2016

Related U.S. Application Data
(63) Continuation of application No. 13/606,959, filed on Sep. 7, 2012, now abandoned.
(60) Provisional application No. 61/532,939, filed on Sep. 9, 2011.

(51) Int. Cl. A23L 2/60; A23L 27/00; A23L 27/30

(52) U.S. Cl. CPC A23L 2/60; A23L 27/36; A23L 27/86; A23V 2002/00

(57) ABSTRACT

Sweetened compositions and methods for preparing the same are provided herein. The sweetened compositions contain a substantially pure natural sweetener and a sweetener taste modulator.

### CROSS REFERENCE TO RELATED APPLICATIONS

This application claims the benefit of U.S. Provisional Application No. 61/532,939 filed Sep. 9, 2011, which is incorporated herein by reference in its entirety.

### FIELD OF THE INVENTION

The invention generally relates to low or non-caloric, sweetened compositions comprising natural sweeteners having an improved, sugar-like tasting quality. The sweetened compositions of the present invention include a substantially pure natural sweetener and a sweetener taste modulator. The substantially pure natural sweetener is present in the sweetened composition in an amount above the natural sweetener's sweetness recognition threshold concentration, while the sweetener taste modulator is present in an amount at or below the sweetener taste modulator's sweetness recognition threshold concentration. The present invention also includes methods of making the improved sweetened compositions disclosed herein.

### BACKGROUND OF THE INVENTION

Carbohydrate sweeteners (e.g., sucrose) have traditionally been used to sweeten foods and beverages. While the taste of carbohydrate sweeteners is familiar and desirable to many consumers, the caloric content of carbohydrate sweeteners is less desirable. Increasingly health-conscious consumers have generated demand for low or no-calorie alternatives to carbohydrate sugars, including saccharin, aspartame, acesulfame-K, cyclamate, neotame and sucralose. While these carbohydrate alternatives remain popular with consumers, there is increasing demand for natural low or non-caloric sweeteners.

Recently, natural sweeteners such as Stevia and Lo Han Guo have garnered much attention being both non-caloric, and natural sweeteners. Stevia sweeteners are derived (e.g., extracted) from Stevia rebaudiana (Bertoni), a perennial shrub of the Asteracae (Compositae) family native to Brazil and Paraguay. The major constituents in the leaves of S. rebaudiana are diterpenoid glycosides of the steviol ent-13-hydroxykaur-16-en-19-oic acid. Specific steviol glycosides that can be isolated from the Stevia plant include stevioside, rebaudioside A, rebaudioside C, dulcoside A, rubusoside, steviolbioside, rebaudioside B, rebaudioside D and rebaudioside F. While some steviol glycosides are sweet, others have intense bitter characteristics, licorice tastes and prolonged aftertastes. Stevioside and rebaudioside A are some of the sweetest and most abundant steviol glycosides that can be obtained from the Stevia plant.

Depending on the methods of extraction, the purity of the Stevia extract varies. Some Stevia sweeteners contain a mixture of steviol glycosides. Stevia sweeteners that contain a mixture of steviol glycosides often elicit taste properties that are objectionable to the consumer.

Other Stevia sweeteners contain primarily one steviol glycoside in very high purity. Methods of obtaining stevioside and rebaudioside A in purities of 95% or greater are known (U.S. Patent Publication No. 2008/02922764 and U.S. Patent Publication No. 20070292582, both to Prakash, et al.).

Although rebaudioside A and stevioside are known to be some of the sweetest steviol glycosides, these compounds actually exhibit unpleasant off-notes (e.g., bitter tastes, licorice tastes, sweetness linger and strong aftertastes) when used in the concentrations necessary to obtain 10% sucrose equivalence, a common metric used to measure the flavor and temporal profile of a sweetener. The cost associated with preparing and obtaining Stevia sweeteners is, at present, significantly higher than traditional carbohydrate or synthetic high-potency sweeteners.

Lo Han Guo, sometimes spelled Lo Han Kuo, is the common name for the Chinese fruit Momordica grosvenorii (Swingle), also called Siraitia grosvenorii, belonging to the Cucurbitaceae family. Siraitia grosvenorii is an herbaceous perennial vine native to southern China, and its Lo Han Guo fruit is well known for its sweet taste. The fruit extract is around 150-300 times sweeter than sugar, and has been used as a natural sweetener in China for nearly a millennium. However, Lo Han Guo has a slower sweetness onset compared to sucrose and a strong sweet lingering aftertaste.

Accordingly, it is desirable to enhance, or increase, the overall perception of the sugar-like taste quality of sweetened compositions comprising natural sweeteners such as Stevia or Lo Han Guo such that the sweetened composition exhibits a taste more like that of sugar.

### SUMMARY OF THE INVENTION

Natural, low or non-caloric sweetened compositions with improved sugar-like tasting qualities are provided herein. The sweetened compositions comprise a natural sweetener selected from a Stevia sweetener, a Lo Han Guo sweetener or a combination thereof, and at least one sweetener taste modulator, wherein the natural sweetener is present in the sweetened composition in an amount above the natural sweetener's sweetness recognition threshold concentration and wherein the at least one sweetener taste modulator is present in an amount at or below the sweetener taste modulator's sweetness recognition threshold concentration. In preferred embodiments, the sweetener taste modulator is a steviol glycoside that is present in an amount at or below the steviol glycoside's sweetness recognition threshold concentration.

The sugar-like tasting quality of the compositions described herein is improved by incorporating certain sweetener taste modulators into the sweetened compositions in amounts at or below the sweetness recognition threshold concentration of the sweetener taste modulator. While the sweetener taste modulators are not perceptibly sweet when present in a composition in an amount below the sweetness threshold recognition concentration, the sweetener taste modulators increase the sugar-like tasting quality of the when in the presence of a Stevia or Lo Han Guo sweetener, as can be determined by comparing the flavor profile and/or temporal profile of the sweetened composition in the presence and absence of the sweetener taste modulator.

In some embodiments, the sweetened compositions comprise a natural sweetener that is a Stevia sweetener. In some embodiments, the sweetener taste modulator is also a steviol glycoside. Notably, the steviol glycosides contained in the Stevia sweetener are different than the steviol glycosides that comprise the sweet taste modulators.

In other embodiments, the sweetened composition comprises a natural sweetener that is a Lo Han Guo sweetener.

In yet other embodiments, the sweetened composition comprises a natural sweetener that is a mixture of a Stevia sweetener and a Lo Han Guo sweetener.

In one embodiment, sweetened composition comprises a Stevia sweetener, a Lo Han Guo sweetener or a combination thereof and at least one sweetener taste modulator is a compound derived from acid-catalyzed degradation of rebaudioside A.

In one embodiment, a sweetened composition comprises a natural sweetener selected from the group consisting of a Stevia sweetener, a Lo Han Guo sweetener or a combination thereof and at least one sweetener taste modulator that is a compound of Formula I:

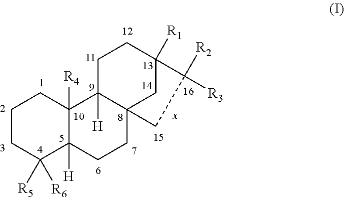

wherein x is a single bond or a double bond;

wherein R₁ is independently selected from the group consisting of hydrogen, hydroxyl, alkyl, a monosaccharide or an oligosaccharide;

wherein R₂ and R₃ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; or
wherein when x is a single bond, R₂ and R₃, taken together, form a carbonyl or alkene; and

wherein when x is a double bond, either R₂ or R₃ is absent;

wherein R₄ and R₅ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; and

wherein R₆ is independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic; —C(O)—OR₇; —COOH; —C(O)—NR₈R₉; —N(N)—NR₁₀R₁₁; C(O)—H; C(S)—R₁₂; S(O)ₙR₁₃ and S(O)₂—NR₁₄R₁₅, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl; and

wherein R₇, R₈, R₉, R₁₀, R₁₁, R₁₂, R₁₃, R₁₄ and R₁₅ are independently selected from the group consisting of a monosaccharide, hydrogen, hydroxy, C₁-C₆ straight alkyl, C₁-C₆ branched alkyl, C₂-C₆ alkenyl, C₃-C₈ cyclic alkyl, heterocyclic, heteroaryl and aryl, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy.

In another embodiment, a sweetened composition comprises a natural sweetener selected from the group consisting of a Stevia sweetener, a Lo Han Guo sweetener or a combination thereof and at least one sweetener taste modulator that is a compound of Formula (Ia):

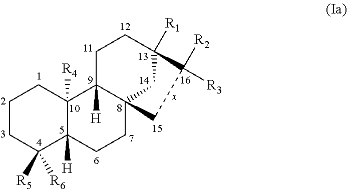

wherein x is a single bond or a double bond; and

wherein R₁ is independently selected from the group consisting of hydrogen, hydroxyl, alkyl, a monosaccharide or an oligosaccharide;

wherein R₂ and R₃ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; or
wherein when x is a single bond, R₂ and R₃, taken together, form a carbonyl or alkene; and

wherein when x is a double bond, either R₂ or R₃ is absent.

wherein R₄ and R₅ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; and

wherein R₆ is independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic; —C(O)—OR₇; —COOH; —C(O)—NR₈R₉; —N(N)—NR₁₀R₁₁; C(O)—H; C(S)—R₁₂; S(O)ₙR₁₃ and S(O)₂—NR₁₄R₁₅, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl;

wherein R₇, R₈, R₉, R₁₀, R₁₁, R₁₂, R₁₃, R₁₄ and R₁₅ are independently selected from the group consisting of a monosaccharide, hydrogen, hydroxy, C₁-C₆ straight alkyl, C₁-C₆ branched alkyl, C₂-C₆ alkenyl, C₃-C₈ cyclic alkyl, heterocyclic, heteroaryl and aryl, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy.

In one embodiment, a sweetened composition comprises a natural sweetener selected from the group consisting of a Stevia sweetener, a Lo Han Guo sweetener or a combination thereof and at least one sweetener taste modulator that is a compound of Formula (II):

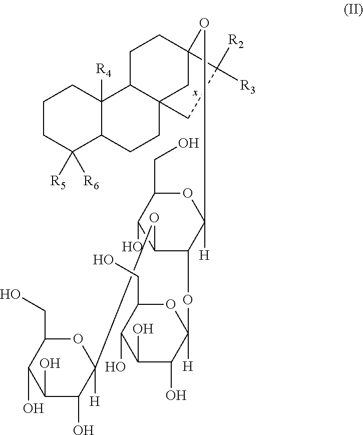

wherein x is a single bond or double bond; and

wherein R₂ and R₃ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; or

wherein when x is a single bond, R₂ and R₃, taken together, form a carbonyl or alkene; and

wherein where x is a double bond, either R₂ or R₃ is absent; and

wherein R₄ and R₅ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; and

wherein R₆ is independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic; —C(O)—OR₇; —COOH; —C(O)—NR₈R₉; —N(N)—NR₁₀R₁₁; C(O)—H; C(S)—R₁₂; S(O)ₙR₁₃ and S(O)₂—NR₁₄R₁₅, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl; and

wherein R₇, R₈, R₉, R₁₀, R₁₁, R₁₂, R₁₃, R₁₄ and R₁₅ are independently selected from the group consisting of a monosaccharide, hydrogen, hydroxy, C₁-C₆ straight alkyl, C₁-C₆ branched alkyl, C₂-C₆ alkenyl, C₃-C₈ cyclic alkyl, heterocyclic, heteroaryl and aryl, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy.

In one embodiment, a sweetened composition comprises a natural sweetener selected from the group consisting of a Stevia sweetener, a Lo Han Guo sweetener or a combination thereof and at least one sweetener taste modulator that is a compound of Formula (IIa):

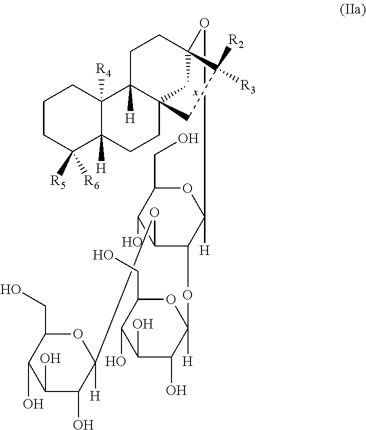

wherein x is a single bond or double bond; and

wherein R₂ and R₃ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; or

wherein when x is a single bond, R₂ and R₃, taken together, form a carbonyl or alkene; and

wherein when x is a double bond, either R₂ or R₃ is absent; and

wherein R₄ and R₅ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; and

wherein R₆ is independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic; —C(O)—OR₇; —COOH; —C(O)—NR₈R₉; —N(N)—NR₁₀R₁₁; C(O)—H; C(S)—R₁₂; S(O)ₙR₁₃ and S(O)₂—NR₁₄R₁₅, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl; and

wherein R₇, R₈, R₉, R₁₀, R₁₁, R₁₂, R₁₃, R₁₄ and R₁₅ are independently selected from the group consisting of a monosaccharide, hydrogen, hydroxy, C₁-C₆ straight alkyl, C₁-C₆ branched alkyl, C₂-C₆ alkenyl, C₃-C₈ cyclic alkyl, heterocyclic, heteroaryl and aryl, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy.

In one embodiment, a sweetened composition comprises a natural sweetener selected from the group consisting of a Stevia sweetener, a Lo Han Guo sweetener or a combination thereof and at least one sweetener taste modulator that is a compound of Formula (III):

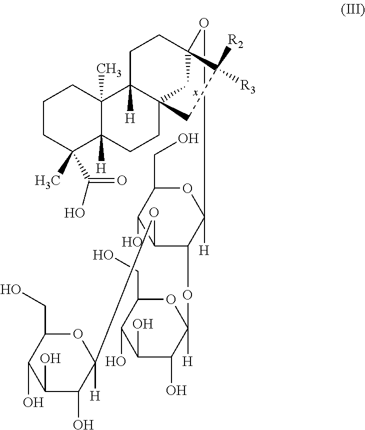

wherein x is a single bond or double bond; and

wherein R₂ and R₃ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; or

wherein when x is a single bond, R₂ and R₃, taken together, form a carbonyl or alkene; and

wherein when x is a double bond, either R₂ or R₃ is absent.

In one embodiment, a sweetened composition comprises a natural sweetener selected from the group consisting of a Stevia sweetener, a Lo Han Guo sweetener or a combination thereof and at least one sweetener taste modulator that is a compound of Formula (IV):

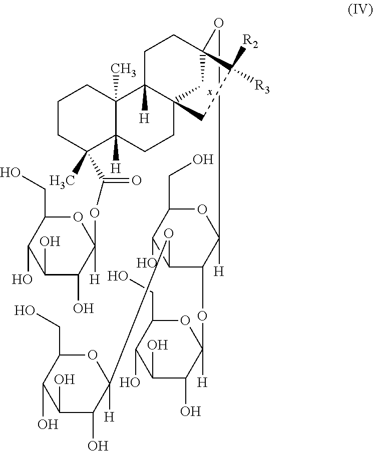

wherein x is a single bond or double bond; and

wherein R₂ and R₃ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; or

wherein when x is a single bond, R₂ and R₃, taken together, form a carbonyl or alkene; and

wherein when x is a double bond, either R₂ or R₃ is absent.

In one embodiment, the at least one sweetener taste modulator is a compound selected from the following group:

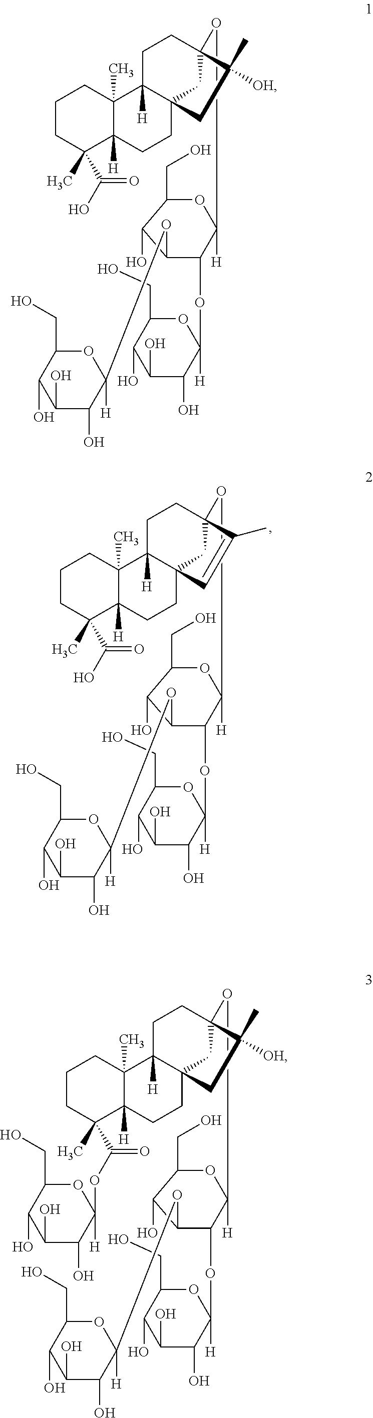

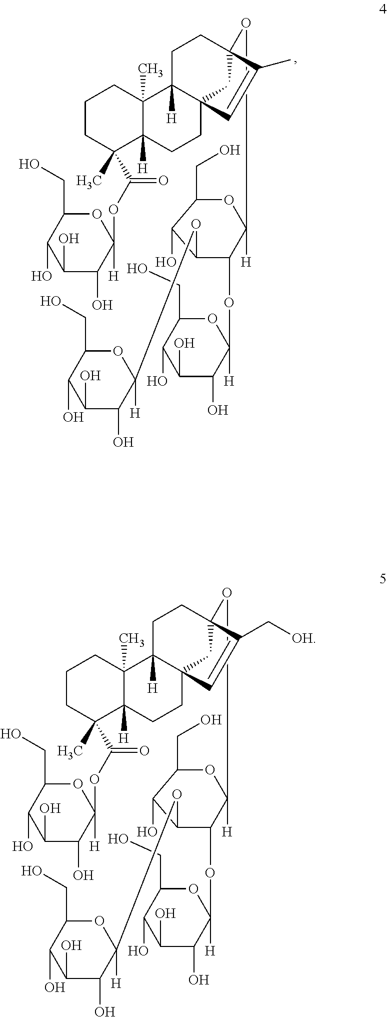

In preferred embodiments, the natural sweetener of the present invention is a Stevia sweetener that comprises substantially pure rebaudioside A, substantially pure rebaudioside D or substantially pure JSS.

In other embodiments, the natural sweetener of the present invention is a Lo Han Guo sweetener that comprises substantially pure mogroside V.

### DETAILED DESCRIPTION

### I. Definitions

The term “alkyl”, as used herein, unless otherwise specified, refers to a saturated straight, branched, or cyclic, primary, secondary, or tertiary hydrocarbon of typically C₁ to C₁₀, and specifically includes methyl, trifluoromethyl, ethyl, propyl, isopropyl, cyclopropyl, butyl, isobutyl, t-butyl, pentyl, cyclopentyl, isopentyl, neopentyl, hexyl, isohexyl, cyclohexyl, cyclohexylmethyl, 3-methylpentyl, 2,2-dimethylbutyl, and 2,3-dimethylbutyl. The term includes both substituted and unsubstituted alkyl groups. Moieties with which the alkyl group can be substituted are selected from the group consisting of hydroxyl, amino, alkylamino, arylamino, alkoxy, aryloxy, nitro, cyano, sulfonic acid, sulfate, phosphonic acid, phosphate, or phosphonate, either unprotected, or protected as necessary, as known to those skilled in the art, for example, as taught in Greene, et al., Protective Groups in Organic Synthesis, Wiley-Interscience, Third Edition, 1999, hereby incorporated by reference.

The term “acyl” refers to a carboxylic acid ester in which the non-carbonyl moiety of the ester group is selected from straight, branched, or cyclic alkyl or lower alkyl, alkoxyalkyl including methoxymethyl, aralkyl including benzyl, aryloxyalkyl such as phenoxymethyl, aryl including phenyl optionally substituted with halogen, C₁ to C₄ alkyl or C₁ to C₄ alkoxy, sulfonate esters such as alkyl or aralkyl sulphonyl including methanesulfonyl, the mono, di or triphosphate ester, trityl or monomethoxytrityl, substituted benzyl, trialkylsilyl (e.g. dimethyl-t-butylsilyl) or diphenylmethylsilyl.

The term “aryl”, as used herein, and unless otherwise specified, refers to phenyl, biphenyl, or naphthyl, and preferably phenyl. The term includes both substituted and unsubstituted moieties. The aryl group can be substituted with one or more moieties selected from the group consisting of hydroxyl, amino, alkylamino, arylamino, alkoxy, aryloxy, nitro, cyano, sulfonic acid, sulfate, phosphonic acid, phosphate, or phosphonate, either unprotected, or protected as necessary, as known to those skilled in the art, for example, as taught in Greene, et al., Protective Groups in Organic Synthesis, Wiley-Interscience, Third Edition, 1999.

The term “sweetness recognition threshold concentration,” as generally used herein, is the lowest known concentration of a sweet compound that is perceivable by the human sense of taste. The sweetness recognition threshold level is specific for a particular compound, and varies based on temperature, matrix, ingredients and/or flavor system. The sweetness recognition threshold concentrations measurements and 5% sucrose equivalence measurements described herein were determined in water at room temperature.

The term “sweetener taste modulator,” as generally used herein, is a compound that heightens, or increases, the perception of sugar-like taste quality if a sweetener when present in combination with the sweetener in an amount at or below the sweetener taste modulator's sweetness recognition threshold level when in combination with a sweetener.

The term “sweetener composition,” as generally used herein, is a composition that comprises at least one sweetener.

The term “sweetened composition,” as generally used herein is a substance containing at least one sweetener that is contacted with the mouth of man or animal, including substances which are taken into and subsequently ejected from the mouth and substances which are drunk, eaten, swallowed or otherwise ingested, and are safe for human or animal consumption when used in a generally acceptable range.

The term “sweetenable composition,” as generally used herein is a substance that is contacted with the mouth of man or animal, including substances which are taken into and subsequently ejected from the mouth and substances which are drunk, eaten, swallowed or otherwise ingested, and are safe for human or animal consumption when used in a generally acceptable range.

The term “sugar-like taste quality,” as generally used herein, refers to properties of sweetener and sweetened compositions that closely resemble that of sucrose. Sucrose has a characteristic flavor profile and temporal profile that are known in the art. All sweeteners other than sucrose are generally compared to the baseline taste qualities of sucrose. Sweeteners or sweetened compositions that exhibit sugar-like taste-qualities have flavor profiles and/or temporal profiles that are similar, comparable, or identical to that of sucrose.

The term “natural sweetener,” as generally used herein, refers to a sweetener that contains, as its primary component, a compound that is isolated from the Lo Han Guo or Stevia plant.

The term “Stevia sweetener,” as generally used herein, refers to a sweetener that contains, as its primary component, a steviol glycoside. In some embodiments, the Stevia sweetener is derived from the plant Stevia rebaudiana, and is present in the sweetened compositions in an amount above the sweetness recognition threshold concentration. In other embodiments, the Stevia sweetener is a degradation product of one or more steviol glycosides that can be isolated from Stevia rebaudiana.

The term “Lo Han Guo sweetener,” as generally used herein, refers to a sweetener that contains, as its primary component, a mogroside. In some embodiments, the Lo Han Guo sweetener is derived from Momordica grosvenorii, and is present in the sweetened compositions an amount above the sweetness recognition threshold concentration.

The term “sweetness intensity,” as generally used herein, refers to any perceptible sweetness. For example, a composition of the disclosure may be slightly more sweet than a composition comprising the at least one sweetener without the at least one sweetener taste modulator.

The term “flavor profile” or “taste profile,” as generally used herein, refers to the intensity of various flavor/taste attributes of a sweetener or sweetened composition. Exemplary flavor/taste attributes are sweetness intensity, bitterness intensity, salty intensity, licorice intensity, cooling intensity, and licorice intensity. Methods of determining the flavor profile of a given sweetener or sweetened composition are known in the art.

The term “temporal profile,” as generally used herein, refers to the detected sucrose equivalence a given sweetener or sweetened composition elicits over time. The temporal profile of most sweeteners is neither constant nor similar. Initially, the detected sucrose equivalence spikes to the maximal response level, then tapers off over time. The longer the taper, the greater the detected sweetness linger (i.e. aftertaste) of a compound or sweetened composition.

The term “licorice,” as generally used herein, refers to a sweet, semi-sweet, bitter, and/or aromatic taste of a sweetener or sweetened composition.

### II. Sweetened Compositions

The sweetened compositions comprise (i) a natural sweetener selected from a Stevia sweetener, a Lo Han Guo sweetener or a combination thereof and (ii) a sweetener taste modulator.

A. Natural Sweeteners

The natural sweetener component of the sweetened composition of the present invention may be selected from a Stevia sweetener, a Lo Han Guo sweetener or a combination thereof.

i.) Stevia Sweeteners

In certain embodiments, the sweetened compositions of the present invention comprise (i) a natural sweetener that is a Stevia sweetener and (ii) a sweetener taste modulator.

Stevia rebaudiana is a plant that is known to have sweet-tasting qualities. The sweet characteristic Stevia rebaudiana depends on the presence of certain naturally occurring compounds found therein, known as steviol glycosides. There are various kinds of steviol glycosides, with the most abundant being stevioside and rebaudioside A. Other known steviol glycosides include stevioside, rebaudioside A, rebaudioside C, dulcoside A, rubusoside, steviolbioside, rebaudioside B, rebaudioside D and rebaudioside F.

The Stevia rebaudiana plant can be processed, to varying degrees, to produce Stevia sweeteners. One example is a crude preparation or extract of dried stevia leaves, in the form of a powder or liquid. Stevia extracts may be prepared in various ways. As one example, a Stevia extract is prepared by mixing ground leaves of Stevia rebaudiana with hot water for 20-30 min. Subsequently, the aqueous extract is removed by draining, using pressure in order to achieve the maximum amount of extract. Several types of infusion/draining processes may be used. The extract is allowed to cool to room temperature. In order to remove impurity particles, the extract may be allowed to rest while particulate matter settles out or it may be centrifuged. The extract contains the sweetener principles, the plant pigments and other water-soluble components. The sweetener principles and the pigments are extracted with a mixture of butanol or isobutanol and a less polar solvent, such as benzene, chloroform or hexane. The organic phase is separated and concentrated until a solid mass is formed. The mass is dissolved in hot methanol. Steviol glycoside crystals form on cooling. The crystals are separated and washed with cold methanol, and finally recrystallized from methanol/water. The resulting material has a high degree of purity (97-98% steviol glycosides) and contains about 4% water.

Stevia extracts generally contain a high percentage of the glycoside diterpenes stevioside and rebaudioside A—the principal sweetening compounds- and smaller amounts of other steviol glycosides. The composition of the extracts depends on the composition of the leaves, influenced by soil and climate, and on the extraction and purification processes used. The impurities occurring in extracts of the Stevia leaves are typical plant materials, such as pigments and saccharides.

The amount of the Stevia sweetener may vary. The Stevia sweetener can be present in the sweetened composition in an amount above the Stevia sweetener's sweetness recognition threshold concentration.

In certain embodiments of the present invention, both the Stevia sweetener and the sweetener taste modulator are steviol glycosides. However, the steviol glycoside(s) of the sweetener taste modulator component and the steviol glycoside(s) of the Stevia sweetener component are different. In one embodiment, the steviol glycoside that is the sole component of the Stevia sweetener (A, for example) is different than the steviol glycoside that is the sole component of the sweetener taste modulator (B, for example).

In another embodiment, the steviol glycoside that constitutes the primary component of the Stevia sweetener (A, for example) in a steviol glycoside mixture (A, B and C, for example) is different than the steviol glycoside that constitutes the primary component of the sweetener taste modulator (D, for example) in a steviol glycoside mixture (D, E and F, for example). It is important to note that a particular steviol glycoside cannot present in both the Stevia sweetener component and the sweetener taste modulator component. The Stevia sweetener component and the sweetener taste modulator component contain completely different mixtures of compounds.

In certain embodiments, the Stevia sweetener is a substantially pure steviol glycoside. The term “substantially pure,” as used herein, generally refers to compositions comprising a compound in at least about 50% purity in a given mixture. Preferably, the purity of the steviol glycoside is greater than about 85% purity, greater than about 90% purity, greater than about 95% purity, greater than about 97% purity. The Stevia sweetener comprising a substantially pure steviol glycoside is selected from the group consisting of rebaudioside A, rebaudioside B, rebaudioside C, rebaudioside D, rebaudioside E, rebaudioside F, steviol, steviolmonoside, steviolbioside, stevioside, rubusoside, dulcoside A. While steviol glycosides other than the substantially pure steviol glycoside which comprises the majority of the Stevia sweetener may be present, the balance of the Stevia sweetener does not comprise steviol glycosides that are also characterized as sweetener taste modulators, as described herein.

In other embodiments, the Stevia sweetener comprises specific mixtures of steviol glycosides. In a preferred embodiment, the Stevia sweetener is JSS. A JSS sweetener comprises nine steviol glycosides (rebaudioside A, rebaudioside B, rebaudioside C, rebaudioside D, rebaudioside F, steviolbioside, stevioside, rubusoside and dulcoside A) that comprise greater than 95% by weight of the sweetener. Typically, JSS comprises, by weight, about 70% stevioside and about 20% rebaudioside A

In a preferred embodiment, the JSS sweetener comprises at least 95% of the nine types of the above-mentioned steviol glycosides by weight. In preferred embodiments, substantially pure JSS comprises, by weight, at least about 50% of the Stevia sweetener, at least about 85% of the Stevia sweetener, at least about 90% of the Stevia sweetener, at least about 95% of the Stevia sweetener, at least about 97% of the Stevia sweetener, at least about 99% of the Stevia sweetener.

In other embodiments, the Stevia sweetener is substantially pure rebaudioside A with a purity of at least about 90% in a steviol glycoside mixture, more preferably with a purity of at least about 95% in a steviol glycoside mixture. In preferred embodiments, substantially pure rebaudioside A comprises, by weight, at least about 50% of the Stevia sweetener, at least about 85% of the Stevia sweetener, at least about 90% of the Stevia sweetener, at least about 95% of the Stevia sweetener, at least about 97% of the Stevia sweetener, at least about 99% of the Stevia sweetener.

In other embodiments, the Stevia sweetener is substantially pure stevioside with a purity of at least about 90% in a steviol glycoside mixture, more preferably with a purity of at least about 95% in a steviol glycoside mixture. In preferred embodiments, substantially pure stevioside comprises at least about 50%, by weight, of the Stevia sweetener, at least about 85% of the Stevia sweetener, at least about 90% of the Stevia sweetener, at least about 95% of the Stevia sweetener, at least about 97% of the Stevia sweetener, at least 99% of the Stevia sweetener.

In other embodiments, the Stevia sweetener is substantially pure rebaudioside D with a purity of at least about 90% in a steviol glycoside mixture, more preferably with a purity of at least about 95% in a steviol glycoside mixture. In preferred embodiments, substantially pure rebaudioside D comprises at least about 50%, by weight, of the Stevia sweetener, at least about 85% of the Stevia sweetener, at least about 90% of the Stevia sweetener, at least about 95% of the Stevia sweetener, at least about 97% of the Stevia sweetener, at least about 99% of the Stevia sweetener.

ii.) Lo Han Guo Sweeteners

In other embodiments, the sweetened compositions of the present invention comprise a (i) natural sweetener that is a Lo Han Guo sweetener and (ii) a sweetener taste modulator.

The amount of the Lo Han Guo sweetener may vary. The Lo Han Guo sweetener may be present in the sweetened composition in an amount above the Lo Han Guo sweetener's sweetness recognition threshold concentrations.

In one embodiment, the Lo Han Guo sweetener is substantially pure mogroside V with a purity of at least about 50% in a mogroside mixture, more preferably with a purity of at least about 55% in a mogroside mixture. In preferred embodiments, substantially pure mogroside V comprises at least about 20%, by weight, of the Lo Han Guo sweetener, at least about 30% of the Lo Han Guo sweetener, at least about 40% of the Lo Han Guo sweetener, at least about 50% of the Lo Han Guo sweetener, at least about 55% of the Lo Han Guo sweetener, at least about 75% of the Lo Han Guo sweetener, at least about 85% of the Lo Han Guo sweetener, at least about 90% of the Lo Han Guo sweetener, at least about 95% of the Lo Han Guo sweetener.

In some embodiments, the natural sweetener is a mixture of Stevia sweetener and Lo Han Guo sweetener.

B. The Sweetener Taste Modulator

i.) Rebaudioside A Degradation Products

The sweetened compositions of the present invention comprise a (i) natural sweetener and (ii) a sweetener taste modulator.

The sweetener taste modulator may comprise one or more degradation products of a steviol glycoside selected from the group consisting of stevioside, rebaudioside A, rebaudioside C, rebaudioside D, rebaudioside E, rebaudioside F and combinations thereof.

Thus, particular embodiments may comprise one or more degradation product of a steviol glycoside selected from the group consisting of stevioside, rebaudioside A, rebaudioside C, rebaudioside D, rebaudioside E, rebaudioside F and combinations thereof. In one embodiment, the degradation product of the steviol glycoside may comprise from about 50% to about 99.5% by weight of a particular degradation compound (on a dry basis), from about 75% to about 99.5%, from about 80% to about 99.5%, from about 85% to about 99.5%, from about 90% to about 99.5%, from about 95% to about 99.5%, from about 97% to about 99.5%, from about 98% to about 99.5%, or from about 99% to about 99.5%.

In some embodiments, the sweetener taste modulator may be a compound derived from acid-catalyzed degradation product of rebaudioside A, referred to herein as a “rebaudioside A degradation product.” The rebaudioside A degradation product sweetener taste modulators of the present invention are present in the sweetened compositions described herein in amounts at or below the sweetness recognition threshold concentration of the sweetener taste modulator, and more specifically, at or below the sweetness recognition threshold concentration of the rebaudioside A degradation product.

Methods for preparing rebaudioside A degradation products are described in U.S. Ser. No. 12/392,439, the contents of which are incorporated herein by reference.

The method for preparing rebaudioside A degradation products generally comprises preparing a solution of either a crude or a substantially pure rebaudioside A composition comprising a rebaudioside A compound and an inorganic acid or base, heating or pressurizing, or a combination thereof, the solution to a temperature and pressure sufficient to react the rebaudioside A compound for a time sufficient to obtain a rebaudioside A degradation product, and recovering the rebaudioside A degradation product. In one embodiment, a temperature sufficient to react the rebaudioside A compound is in the range of about 22° C. to about 110° C., particularly in the range of about 50 to about 110° C., more particularly from about 65 to about 95° C., and still more particularly from about 75 to about 85° C. Any suitable means of heating known to those of ordinary skill in the art may be used to heat the solution, non-limiting examples of which include sunlight or elevated ambient temperatures. In one embodiment, a time sufficient to react the rebaudioside A compound is in the range of about 0.5 to about 24 hours.

Non-limiting examples of inorganic acids suitable for use in embodiments herein include phosphoric acid, phosphorous acid, polyphosphoric acid, hydrochloric acid, sulfuric acid, nitric acid, carbonic acid, sodium dihydrogen phosphate, any organic acids, citric acid, lactic acid, acetic acid and combinations thereof. Non-limiting examples of inorganic bases suitable for use in embodiments herein include sodium hydroxide, potassium hydroxide, sodium carbonate, potassium carbonate, magnesium carbonate, calcium carbonate and combinations thereof. Not wishing to be bound by any theory, it is believed that the use of an acid will result in the hydration of the alkene and/or cleaving of the ester while the use of a base will result in a saponification reaction requiring addition of an inorganic acid to reform the carboxylic acid.

As used herein, a crude rebaudioside A composition comprises purity levels of a rebaudioside A compound less than about 80% rebaudioside A compound by weight on a dry basis, at less than about 70% by weight on a dry basis, or at less than about 60% by weight on a dry basis.

The resulting rebaudioside A degradation product generally comprises a mixture of a supernatant and a precipitate. In a particular embodiment, the step of recovering the rebaudioside A degradation product comprises isolating the supernatant, the precipitate, or a combination thereof. The rebaudioside A degradation product may be recovered using any suitable solid-liquid separation techniques. For example, the degradation product of the supernatant and precipitate may be isolated from each other by decanting the supernatant from the precipitate. Other separation techniques may utilize centrifugal force, non-limiting examples of which include vertical and horizontal perforated basket centrifuge, solid bowl centrifuge, decanter centrifuge, peeler type centrifuge, pusher type centrifuge, Heinkel type centrifuge, disc stack centrifuge and cyclone separation. In addition, separation of the rebaudioside A degradation product in the supernatant and precipitate may be enhanced by any of pressure, vacuum, and gravity filtration methods, that include, without limitation, the use of belt, drum, nutsche-type, leaf, plate, Rosenmund type, sparkler type, and bag filters and filter press.

The recovered rebaudioside A degradation product of the supernatant optionally may be clarified with an aqueous organic solution while the recovered rebaudioside A degradation product of the precipitate optionally may be dissolved in an aqueous organic solution (e.g., methanol, ethanol, isopropanol, n-propanol or mixtures).

In some particular embodiments, the rebaudioside A degradation product is be purified from the supernatant or precipitate by normal phase and/or reversed-phase column chromatography. Suitable columns for purifying the rebaudioside A degradation product may be determined by one of ordinary skill in the art without undue experimentation. In particular embodiments, the resulting fractions of rebaudioside A degradation product may be reprocessed (e.g., using column chromatography or other methods of purification) to further purify the rebaudioside A degradation products. In still other embodiments, the resulting fractions of rebaudioside A degradation product may be concentrated using any suitable concentration method known to those of ordinary skill in the art (e.g., high performance liquid chromatography).

In one embodiment, the rebaudioside A degradation product may comprise from about 50% to about 99.5% by weight of a rebaudioside A degradation compound (on a dry basis), from about 75% to about 99.5%, from about 80% to about 99.5%, from about 85% to about 99.5%, from about 90% to about 99.5%, from about 95% to about 99.5%, from about 97% to about 99.5%, from about 98% to about 99.5%, or from about 99% to about 99.5%.

ii). Steviol Glycosides

In preferred embodiments, the sweetener taste modulator of the present invention is a steviol glycoside, or a mixture of steviol glycosides. In other embodiments, the at least one sweetener taste modulator can include a mixture of rebaudioside A degradation products and steviol glycosides. The steviol glycoside sweetener taste modulators of the present invention are present in the sweetened compositions described herein in amounts at or below the sweetness recognition threshold concentration of the sweetener taste modulator, and more specifically, at or below the sweetness recognition threshold concentration of the steviol glycoside.

In one embodiment, a sweetened composition comprises a natural sweetener selected from the group consisting of a Stevia sweetener, a Lo Han Guo sweetener or a combination thereof and at least one sweetener taste modulator that is a compound of Formula I:

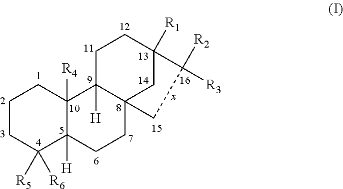

wherein x is a single bond or a double bond

wherein R₁ is independently selected from the group consisting of hydrogen, hydroxyl, alkyl, a monosaccharide or an oligosaccharide;

wherein R₂ and R₃ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; or
wherein when x is a single bond, R₂ and R₃, taken together, form a carbonyl or alkene; and

wherein when x is a double bond, either R₂ or R₃ is absent;

wherein R₄ and R₅ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; and

wherein R₆ is independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic; —C(O)—OR₇; —COOH; —C(O)—NR₈R₉; —N(N)—NR₁₀R₁₁; C(O)—H; and C(S)—R₁₂; S(O)ₙR₁₃ and S(O)₂—NR₁₄R₁₅, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl; and

wherein R₇, R₈, R₉, R₁₀, R₁₁, R₁₂, R₁₃, R₁₄ and R₁₅ are independently selected from the group consisting of a monosaccharide, hydrogen, hydroxy, C₁-C₆ straight alkyl, C₁-C₆ branched alkyl, C₂-C₆ alkenyl, C₃-C₈ cyclic alkyl, heterocyclic, heteroaryl and aryl, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy.

In another embodiment, the at least one sweetener taste modulator is a compound of Formula (I),

wherein R₁ is an oligosaccharide;

wherein R₂ and R₃ are independently selected from the group consisting of
hydrogen, hydroxyl, hydroxyalkyl, and C₁-C₆ straight alkyl,

wherein R₄ and R₅ are C₁-C₆ straight alkyl;

wherein R₆ is selected from the group consisting of —COOH and C(O)—OR₇;
wherein R₇ is a monosaccharide; and

wherein x is a single bond.

In yet another embodiment, the at least one sweetener taste modulator is a compound of Formula (I),

wherein R₁ is an oligosaccharide;

wherein R₂ is independently selected from the group consisting of
hydrogen, hydroxyl, hydroxyalkyl, and C₁-C₆ straight alkyl;

wherein R₃ is absent;

wherein R₄ and R₅ are C₁-C₆ straight alkyl;

wherein R₆ is selected from the group consisting of —COOH and C(O)—OR₇;

wherein R₇ is a monosaccharide; and

wherein x is a double bond.

One of ordinary skill in the art will appreciate that the embodiments of the at least one sweetener taste modulators comprise one or more stereocenters, each stereocenter may be in either the R or S configuration, depending on the arrangement and orientation of the atoms in space. Unless otherwise indicated, it should be understood that the embodiments of sweetener taste modulator may be of any suitable stereochemical configuration.

In another embodiment, a sweetened composition comprises a natural sweetener selected from the group consisting of a Stevia sweetener, a Lo Han Guo sweetener or a combination thereof and at least one sweetener taste modulator that is a compound of Formula (Ia):

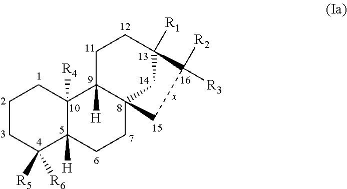

wherein x is a single bond or a double bond; and

wherein R₁ is independently selected from the group consisting of hydrogen, hydroxyl, alkyl, a monosaccharide or an oligosaccharide;

wherein R₂ and R₃ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; or
wherein when x is a single bond, R₂ and R₃, taken together, form a carbonyl or alkene; and

wherein when x is a double bond, either R₂ or R₃ is absent.

wherein R₄ and R₅ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; and

wherein R₆ is independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic; —C(O)—OR₇; —COOH; —C(O)—NR₈R₉; —N(N)—NR₁₀R₁₁; C(O)—H; C(S)—R₁₂; S(O)ₙR₁₃ and S(O)₂—NR₁₄R₁₅, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl;

wherein R₇, R₈, R₉, R₁₀, R₁₁, R₁₂, R₁₃, R₁₄ and R₁₅ are independently selected from the group consisting of a monosaccharide, hydrogen, hydroxy, C₁-C₆ straight alkyl, C₁-C₆ branched alkyl, C₂-C₆ alkenyl, C₃-C₈ cyclic alkyl, heterocyclic, heteroaryl and aryl, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy.

In one embodiment, the at least one sweetener taste modulator is a compound of Formula (Ia),

wherein R₁ is an oligosaccharide;

wherein R₂ and R₃ are independently selected from the group consisting of
hydrogen, hydroxyl, hydroxyalkyl, and C₁-C₆ straight alkyl,

wherein R₄ and R₅ are C₁-C₆ straight alkyl;

wherein R₆ is selected from the group consisting of —COOH and C(O)—OR₇;
wherein R₇ is a monosaccharide; and

wherein x is a single bond.

In another embodiment, the at least one sweetener taste modulator is a compound of Formula (Ia),

wherein R₁ is an oligosaccharide;

wherein R₂ is independently selected from the group consisting of

hydrogen, hydroxyl, hydroxyalkyl, and C₁-C₆ straight alkyl;
wherein R₃ is absent;

wherein R₄ and R₅ are C₁-C₆ straight alkyl;

wherein R₆ is selected from the group consisting of —COOH and C(O)—OR₇;

wherein R₇ is a monosaccharide; and

wherein x is a double bond.

In one embodiment, a sweetened composition comprises a natural sweetener selected from the group consisting of a Stevia sweetener, a Lo Han Guo sweetener or a combination thereof and at least one sweetener taste modulator that is a compound of Formula (II):

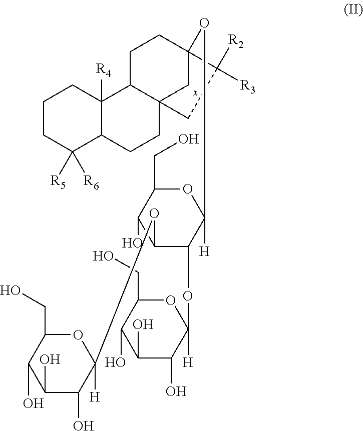

wherein x is a single bond or double bond; and

wherein R₂ and R₃ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; or

wherein when x is a single bond, R₂ and R₃, taken together, form a carbonyl or alkene; and

wherein where x is a double bond, either R₂ or R₃ is absent; and

wherein R₄ and R₅ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; and

wherein R₆ is independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic; —C(O)—OR₇; —COOH; —C(O)—NR₈R₉; —N(N)—NR₁₀R₁₁; C(O)—H; C(S)—R₁₂; S(O)ₙR₁₃ and S(O)₂—NR₁₄R₁₅, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl; and

wherein R₇, R₈, R₉, R₁₀, R₁₁, R₁₂, R₁₃, R₁₄ and R₁₅ are independently selected from the group consisting of a monosaccharide, hydrogen, hydroxy, C₁-C₆ straight alkyl, C₁-C₆ branched alkyl, C₂-C₆ alkenyl, C₃-C₈ cyclic alkyl, heterocyclic, heteroaryl and aryl, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy.

In another embodiment, the at least one sweetener taste modulator is a compound of Formula (II),

wherein R₂ and R₃ are independently selected from the group consisting of
hydrogen, hydroxyalkyl, and C₁-C₆ straight alkyl,

wherein R₄ and R₅ are C₁-C₆ straight alkyl;

wherein R₆ is selected from —COOH or —C(O)—OR₇;
wherein R₇ is a monosaccharide; and

wherein x is a single bond.

In yet another embodiment, the at least one sweetener taste modulator is a compound of Formula (II),

wherein R₂ is selected from the group consisting of hydrogen, hydroxyalkyl and C₁-C₆ straight alkyl,
wherein R₃ is absent;

wherein R₄ and R₅ are C₁-C₆ straight alkyl;

wherein R₆ is selected from —COOH or —C(O)—OR₇;

wherein R₇ is a monosaccharide; and

wherein x is a double bond.

In one embodiment, a sweetened composition comprises a natural sweetener selected from the group consisting of a Stevia sweetener, a Lo Han Guo sweetener or a combination thereof and at least one sweetener taste modulator that is a compound of Formula (IIa):

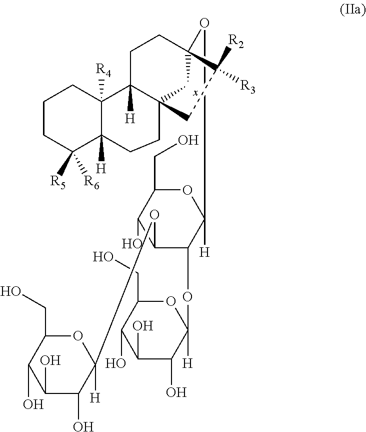

wherein x is a single bond or double bond; and

wherein R₂ and R₃ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; or

wherein when x is a single bond, R₂ and R₃, taken together, form a carbonyl or alkene; and

wherein when x is a double bond, either R₂ or R₃ is absent; and

wherein R₄ and R₅ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; and

wherein R₆ is independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic; —C(O)—OR₇; —COOH; —C(O)—NR₈R₉; —N(N)—NR₁₀R₁₁; C(O)—H; C(S)—R₁₂; S(O)ₙR₁₃ and S(O)₂—NR₁₄R₁₅, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl; and

wherein R₇, R₈, R₉, R₁₀, R₁₁, R₁₂, R₁₃, R₁₄ and R₁₅ are independently selected from the group consisting of a monosaccharide, hydrogen, hydroxy, C₁-C₆ straight alkyl, C₁-C₆ branched alkyl, C₂-C₆ alkenyl, C₃-C₈ cyclic alkyl, heterocyclic, heteroaryl and aryl, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy.

In one embodiment, the at least one sweetener taste modulator is a compound of Formula (IIa),

wherein R₂ and R₃ are independently selected from the group consisting of
hydrogen, hydroxyalkyl, and C₁-C₆ straight alkyl,

wherein R₄ and R₅ are C₁-C₆ straight alkyl;

wherein R₆ is selected from —COOH or —C(O)—OR₇;
wherein R₇ is a monosaccharide; and

wherein x is a single bond.

In another embodiment, the at least one sweetener taste modulator is a compound of Formula (IIa),

wherein R₂ is C₁-C₆ straight alkyl and R₃ is hydroxyl;

wherein R₄ and R₅ are C₁-C₆ straight alkyl;

wherein R₆ is selected from —COOH or —C(O)—OR₇;
wherein R₇ is a monosaccharide; and

wherein x is a single bond.

In another embodiment, the at least one sweetener taste modulator is a compound of Formula (IIa),

wherein R₂ is selected from the group consisting of hydrogen, hydroxyalkyl and C₁-C₆ straight alkyl,
wherein R₃ is absent;

wherein R₄ and R₅ are C₁-C₆ straight alkyl;

wherein R₆ is selected from —COOH or —C(O)—OR₇;

wherein R₇ is a monosaccharide; and

wherein x is a double bond.

In yet another embodiment, the at least one sweetener taste modulator is a compound of Formula (IIa),

wherein R₂ is hydroxyalkyl and R₃ is absent;

wherein R₄ and R₅ are C₁-C₆ straight alkyl;

wherein R₆ is selected from —COOH or —C(O)—OR₇;

wherein R₇ is a monosaccharide; and

wherein x is a double bond.

In a more particular embodiment, the at least one sweetener taste modulator of Formula (IIa) is selected from the group consisting of:

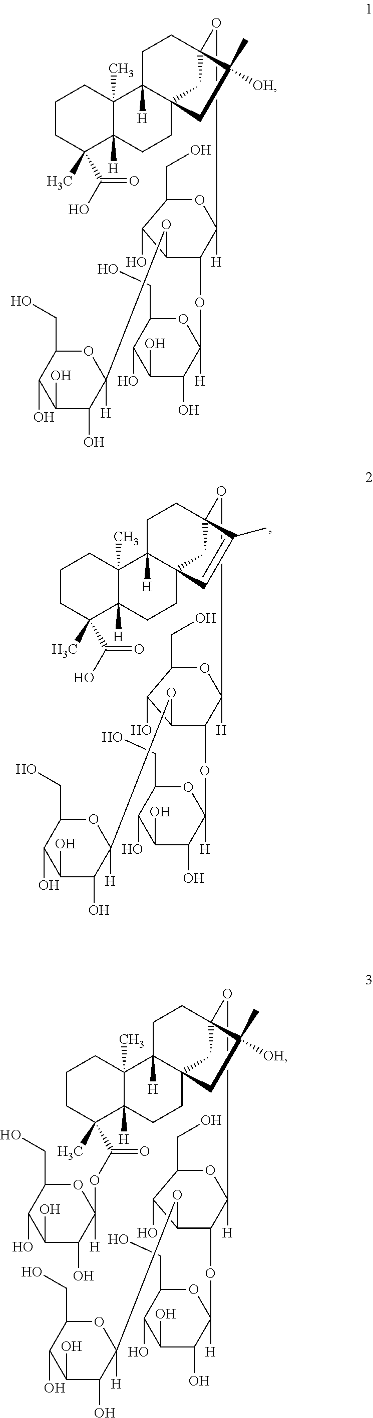

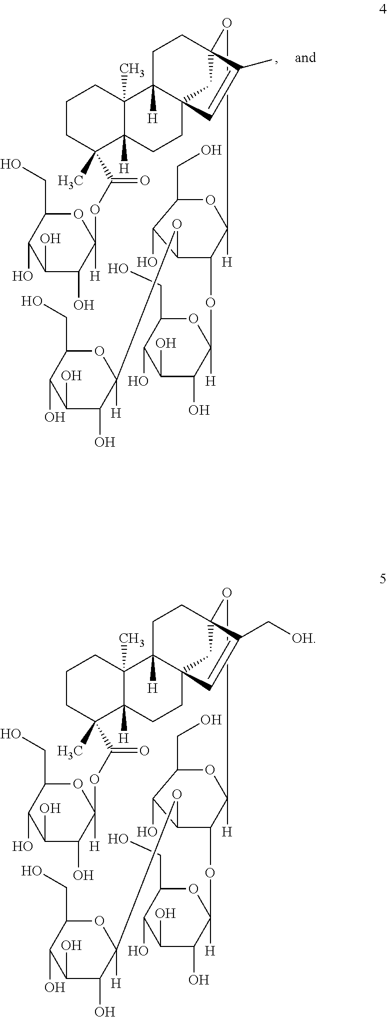

In one embodiment, a sweetened composition comprises a natural sweetener selected from the group consisting of a Stevia sweetener, a Lo Han Guo sweetener or a combination thereof and at least one sweetener taste modulator that is a compound of Formula (III):

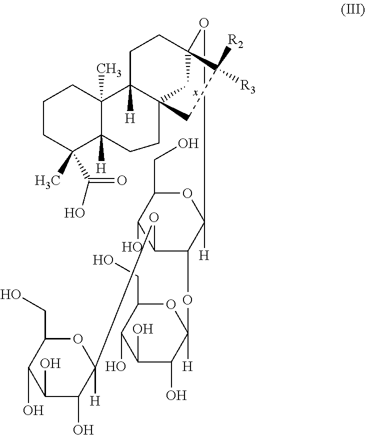

wherein x is a single bond or double bond; and

wherein R₂ and R₃ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; or

wherein when x is a single bond, R₂ and R₃, taken together, form a carbonyl or alkene; and

wherein when x is a double bond either R₂ or R₃ is absent.

In one embodiment, the at least one sweetener taste modulator is a compound of Formula (III),

wherein R₂ and R₃ are independently selected from the group consisting of
hydrogen, hydroxyalkyl, and C₁-C₆ straight alkyl; and

wherein x is a single bond.

In one embodiment, the at least one sweetener taste modulator is a compound of Formula (III),

wherein R₂ is C₁-C₆ straight alkyl and R₃ is absent, and

wherein x is a double bond.

In one embodiment, the at least one sweetener taste modulator is a compound selected from the group consisting of:

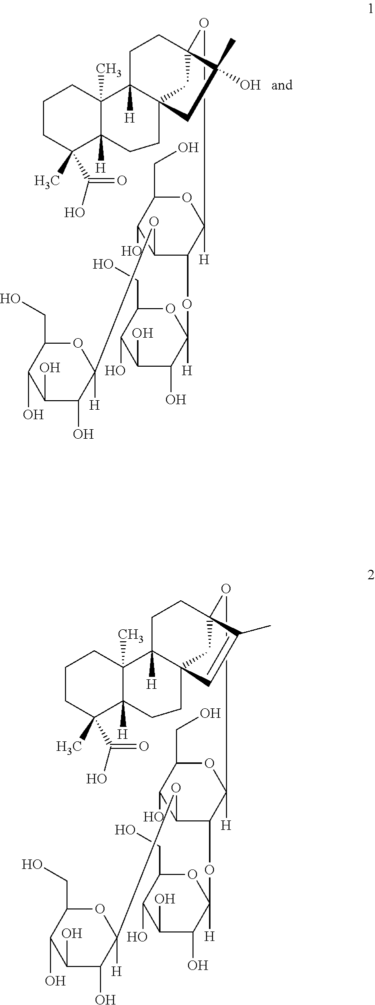

In one embodiment, a sweetened composition comprises a natural sweetener selected from the group consisting of a Stevia sweetener, a Lo Han Guo sweetener or a combination thereof and at least one sweetener taste modulator that is a compound of Formula (IV):

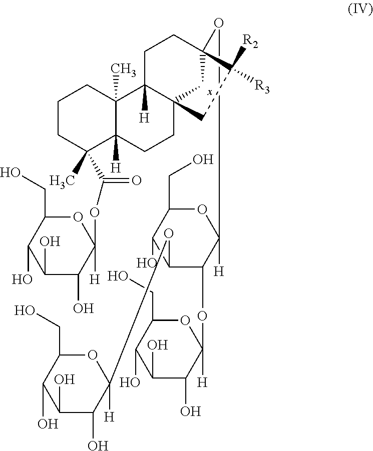

wherein x is a single bond or double bond; and

wherein R₂ and R₃ are independently selected from the group consisting of hydrogen; hydroxyl; hydoxyalkyl; halo; amino, thio, cyano, C₁-C₆ straight alkyl, C₁-C₆ branched alkyl, C₂-C₆ alkenyl, C₃-C₈ cyclic alkyl, heterocyclic, heteroaryl and aryl; C₁-C₆ alkyoxy; aryl; heteroaryl; heterocyclic, wherein all may be optionally substituted by one or more independently selected from the group consisting of halo, alkyl, lower alkyl, acyl, oxo, hydroxy, hydroxyalkyl, alkoxy, heterocyclic, heteroaryl, cyano, amino, aminoalkyl, and carboxy; or

wherein when x is a single bond, R₂ and R₃, taken together, form a carbonyl or alkene; and

wherein when x is a double bond, either R₂ or R₃ is absent.

In one embodiment, the at least one sweetener taste modulator is a compound of Formula (IV),

wherein R₂ and R₃ are independently selected from the group consisting of
hydrogen, hydroxyalkyl, and C₁-C₆ straight alkyl; and

wherein x is a single bond.

In one embodiment, the at least one sweetener taste modulator is a compound of Formula (IV),

wherein R₂ is hydroxyalkyl or C₁-C₆ straight alkyl;

R₃ is absent, and

wherein x is a double bond.

In one embodiment, the at least one sweetener taste modulator is a compound selected from the group consisting of:

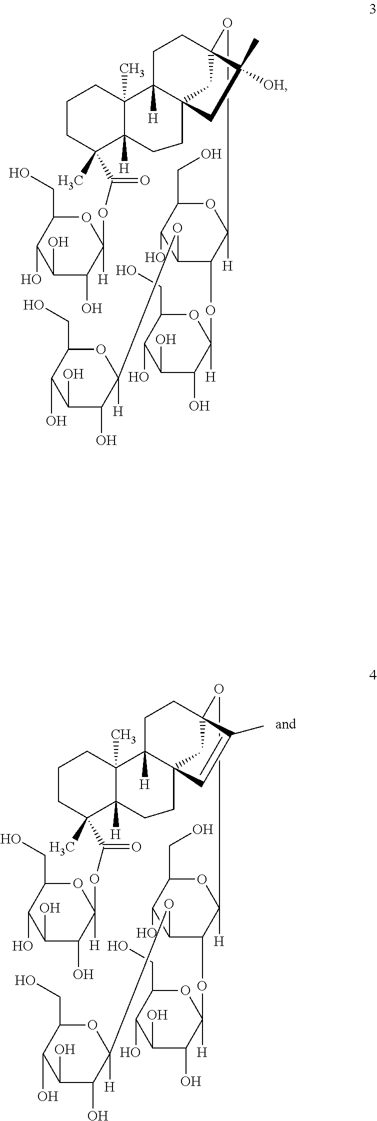

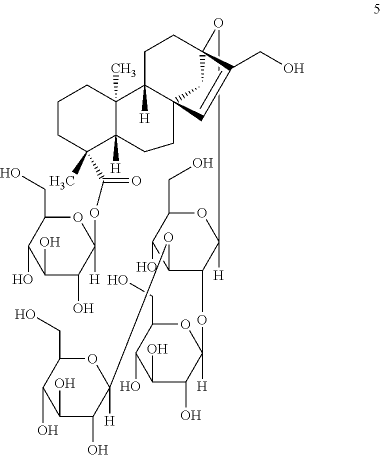

In still other embodiments, the at least one sweetener taste modulator is steviol glucoronide:

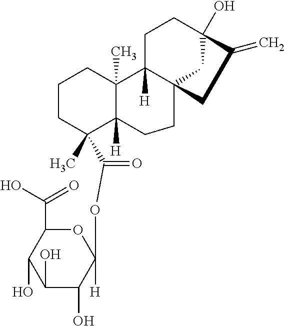

The concentration of the sweetener taste modulator in a given sweetened composition varies based on the identity of both the natural sweetener (Stevia or Lo Han Guo) and the sweetener taste modulator. In some embodiments, the sweetener taste modulator is present in an amount ranging from about 0.1 ppm to about 1000 ppm. In another embodiment, the sweetener taste modulator is present in the composition in an amount ranging from about 5 ppm to about 900 ppm, more preferably between about 5 to about 700 ppm, more preferably between about 5 ppm and about 500 ppm, more preferably between about 10 ppm and about 100 ppm.

C. Sweetened Compositions

i. Rebaudioside A

In certain embodiments the natural sweetener is a Stevia sweetener that comprises substantially pure rebaudioside A. In such embodiments, rebaudioside A is present in a sweetened composition in an amount above its sweetness recognition threshold concentration, about 12.6 ppm. In other embodiments, the substantially pure rebaudioside A is present in an amount 5% above its sweetness recognition threshold concentration, about 10% above its sweetness recognition threshold concentration, about 15% above its sweetness recognition threshold concentration, about 20% above its sweetness recognition threshold concentration. In preferred embodiments, the substantially pure rebaudioside A is present in the sweetened composition in an amount between about 15 ppm and about 2,000 ppm. In a preferred embodiment, the substantially pure rebaudioside A is present in an amount of about 585 ppm. In a more preferred embodiment, the substantially pure rebaudioside A is present in an amount of about 303 ppm.

Sweetened compositions wherein the Stevia sweetener comprises substantially pure rebaudioside A preferably also comprise at least one sweetener taste modulator, different from rebaudioside A, present in an amount at or below sweetness recognition threshold concentration, selected from the group consisting of a compound of Formula I, a compound of Formula Ia, a compound of Formula II, a compound of Formula IIa, a compound of Formula III, a compound of Formula IV and combinations thereof.

In other embodiments wherein the Stevia sweetener comprises substantially pure rebaudioside A, the at least one sweetener taste modulator, present in an amount at or below sweetness recognition threshold concentration, is selected from the group consisting of compound 1, compound 2, compound 3, compound 4, compound 5 and combinations thereof.

In one embodiment, the sweetened compositions comprise a Stevia sweetener that comprises substantially pure rebaudioside A, present in an amount above the sweetness recognition threshold concentration, and the sweetener taste modulator 1, present in at amount at or below sweetness recognition threshold concentration. In another embodiment, the sweetened compositions comprise a Stevia sweetener that comprises substantially pure rebaudioside A, present in an amount above the sweetness recognition threshold concentration, and the sweetener taste modulator 2, present in an amount at or below the sweetness recognition threshold concentration. In another embodiment, the sweetened compositions comprise a Stevia sweetener that comprises substantially pure rebaudioside A, present in an amount above the sweetness recognition threshold concentration, and the sweetener taste modulator 3, present in an amount at or below the sweetness recognition threshold concentration. In yet another embodiment, the sweetened compositions comprise a Stevia sweetener that comprises substantially pure rebaudioside A, present in an amount above the sweetness recognition threshold concentration, and the sweetener taste modulator 4, present in an amount at or below the sweetness recognition threshold concentration. In yet another embodiment, the sweetened compositions comprise a Stevia sweetener that comprises substantially pure rebaudioside A, present in an amount above the sweetness recognition threshold concentration, and the sweetener taste modulator 5, present in an amount at or below the sweetness recognition threshold concentration. In yet other embodiments, the sweetened compositions comprise a Stevia sweetener comprising substantially pure rebaudioside A, present in an amount above the sweetness recognition threshold concentration, and a mixture of sweetener taste modulators, present in an amount at or below sweetness recognition threshold concentrations, selected from the group consisting of compound 1, compound 2, compound 3, compound 4, compound 5 and combinations thereof.

ii. JSS

In certain embodiments the natural sweetener is a Stevia sweetener that comprises substantially pure JSS. In such embodiments, the JSS Stevia sweetener is present in the sweetened composition an amount above its sweetness recognition threshold concentration, about 14 ppm. In other embodiments, the JSS Stevia sweetener is present in an amount about 5% above its sweetness recognition threshold concentration, about 10% above its sweetness recognition threshold concentration, about 15% above its sweetness recognition threshold concentration, about 20% above its sweetness recognition threshold concentration. In preferred embodiments, the JSS Stevia sweetener is present in an amount between about 15 ppm and about 2,000 ppm. In a more preferred embodiment, the JSS Stevia sweetener is present in the sweetened compositions in an amount of about 380 ppm.

Sweetened compositions wherein the Stevia sweetener comprises substantially pure JSS also comprise at least one sweetener taste modulator, present in an amount at or below sweetness recognition threshold concentration, selected from the group consisting of a compound of Formula I, a compound of Formula Ia, a compound of Formula II, a compound of Formula IIa, a compound of Formula III, a compound of Formula IV and combinations thereof. The sweetener taste modulator and the compounds that comprise the substantially pure JSS sweetener are chemically distinct.

In other embodiments wherein the Stevia sweetener comprises substantially pure JSS, the at least one sweetener taste modulator, present in an amount at or below sweetness recognition threshold concentration, is selected from the group consisting of compound 1, compound 2, compound 3, compound 4, compound 5 and combinations thereof.

In one embodiment, the sweetened compositions comprise a Stevia sweetener that comprises substantially pure JSS, present in an amount above the sweetness recognition threshold concentration, and the sweetener taste modulator 1, present in at amount at or below sweetness recognition threshold concentration. In another embodiment, the sweetened compositions comprise a Stevia sweetener that comprises substantially pure JSS, present in an amount above the sweetness recognition threshold concentration, and the sweetener taste modulator 2, present in an amount at or below the sweetness recognition threshold concentration. In another embodiment, the sweetened compositions comprise a Stevia sweetener that comprises substantially pure JSS, present in an amount above the sweetness recognition threshold concentration, and the sweetener taste modulator 3, present in an amount at or below the sweetness recognition threshold concentration. In yet another embodiment, the sweetened compositions comprise a Stevia sweetener that comprises substantially pure JSS, present in an amount above the sweetness recognition threshold concentration, and the sweetener taste modulator 4, present in an amount at or below the sweetness recognition threshold concentration. In yet another embodiment, the sweetened compositions comprise a Stevia sweetener that comprises substantially pure JSS, present in an amount above the sweetness recognition threshold concentration, and the sweetener taste modulator 5, present in an amount at or below the sweetness recognition threshold concentration. In yet other embodiments, the sweetened compositions comprise a Stevia sweetener that comprises substantially pure JSS and a mixture of sweetener taste modulators, present in an amount at or below sweetness recognition threshold concentrations, selected from the group consisting of compound 1, compound 2, compound 3, compound 4, compound 5 and combinations thereof

iii. Rebaudioside D

In certain embodiments the natural sweetener is a Stevia sweetener that comprises substantially pure rebaudioside D. In such embodiments, the substantially pure rebaudioside D Stevia sweetener is present in the sweetened composition above its sweetness recognition threshold concentration, about 25 ppm. In other embodiments, the substantially pure rebaudioside D Stevia sweetener is present in an amount 5% above its sweetness recognition threshold concentration, 10% above its sweetness recognition threshold concentration, 15% above its sweetness recognition threshold concentration, 20% above its sweetness recognition threshold concentration. In preferred embodiments, the substantially pure rebaudioside D Stevia sweetener is present in an amount between about 25 and about 2,000 ppm. In a more preferred embodiment, the substantially pure rebaudioside D Stevia sweetener is present in an amount of about 303 ppm.

Sweetened compositions wherein the Stevia sweetener comprises substantially pure rebaudioside D preferably also comprise at least one sweetener taste modulator present, different from rebaudioside D, in an amount at or below sweetness recognition threshold concentration selected from the group consisting of a compound of Formula I, a compound of Formula Ia, a compound of Formula II, a compound of Formula IIa, a compound of Formula III, a compound of Formula IV and combinations thereof.

In embodiments wherein the Stevia sweetener comprises substantially pure rebaudioside D, the at least one sweetener taste modulator, present in an amount at or below sweetness recognition threshold concentration, is selected from the group consisting of compound 1, compound 2, compound 3, compound 4, compound 5 and combinations thereof.

In one embodiment, the sweetened compositions comprise a Stevia sweetener that comprises substantially pure rebaudioside D, present in an amount above the sweetness recognition threshold concentration, and the sweetener taste modulator 1, present in at amount at or below sweetness recognition threshold concentration. In another embodiment, the sweetened compositions comprise a Stevia sweetener that comprises substantially pure rebaudioside D, present in an amount above the sweetness recognition threshold concentration, and the sweetener taste modulator 2, present in an amount at or below the sweetness recognition threshold concentration. In another embodiment, the sweetened compositions comprise a Stevia sweetener that comprises substantially pure rebaudioside D, present in an amount above the sweetness recognition threshold concentration, and the sweetener taste modulator 3, present in an amount at or below the sweetness recognition threshold concentration. In yet another embodiment, the sweetened compositions comprise a Stevia sweetener that comprises substantially pure rebaudioside D, present in an amount above the sweetness recognition threshold concentration, and the sweetener taste modulator 4, present in an amount at or below the sweetness recognition threshold concentration. In yet another embodiment, the sweetened compositions comprise a Stevia sweetener that comprises substantially pure rebaudioside D, present in an amount above the sweetness recognition threshold concentration, and the sweetener taste modulator 5, present in an amount at or below the sweetness recognition threshold concentration. In yet other embodiments, the sweetened compositions comprise a Stevia sweetener that comprises substantially pure rebaudioside D, present in an amount above the sweetness recognition threshold concentration, and a mixture of sweetener taste modulators, present in an amount at or below sweetness recognition threshold concentrations, selected from the group consisting of compound 1, compound 2, compound 3, compound 4, compound 5 and combinations thereof.

iii. Mogroside V

In certain embodiments the natural sweetener is a Lo Han Guo sweetener that comprises substantially pure mogroside V. In such embodiments, the substantially pure mogroside V of the Lo Han Guo sweetener is present in the sweetened composition above its sweetness recognition threshold concentration, about 15 ppm. In other embodiments, the substantially pure mogroside V of Lo Han Guo sweetener is present in an amount about 5% above its sweetness recognition threshold concentration, about 10% above its sweetness recognition threshold concentration, about 15% above its sweetness recognition threshold concentration, about 20% above its sweetness recognition threshold concentration. In preferred embodiments, the substantially pure mogroside V of the Lo Han Guo sweetener is present in the sweetened composition in an amount of about 15 ppm and about 2,000 ppm. In a preferred embodiment, the substantially pure mogroside V of the Lo Han Guo sweetener is present in about 480 ppm. In a more preferred embodiment, the substantially pure mogroside V of the Lo Han Guo sweetener is present in an amount of about 109 ppm.

Sweetened compositions wherein the Lo Han Guo sweetener comprises substantially pure mogroside V preferably also comprise at least one sweetener taste modulator, different from mogroside V, in an amount at or below sweetness recognition threshold concentration selected from the group consisting of a compound of Formula I, a compound of Formula Ia, a compound of Formula II, a compound of Formula IIa, a compound of Formula III, a compound of Formula IV and combinations thereof.

In other embodiments, when the Lo Han Guo sweetener comprises substantially pure mogroside V, the at least one sweetener taste modulator, present in an amount at or below sweetness recognition threshold concentration, is selected from the group consisting of compound 1, compound 2, compound 3, compound 4, compound 5 and combinations thereof.

In one embodiment, the sweetened compositions comprise a Lo Han Guo sweetener that comprises substantially pure mogroside V, present in an amount above the sweetness recognition threshold concentration, and the sweetener taste modulator 1, present in at amount at or below sweetness recognition threshold concentration. In another embodiment, the sweetened compositions comprise a Lo Han Guo sweetener that comprises substantially pure mogroside V, present in an amount above the sweetness recognition threshold concentration, and the sweetener taste modulator 2, present in an amount at or below the sweetness recognition threshold concentration. In another embodiment, the sweetened compositions comprise a Lo Han Guo sweetener that comprises substantially pure mogroside V, present in an amount above the sweetness recognition threshold concentration, and the sweetener taste modulator 3, present in an amount at or below the sweetness recognition threshold concentration. In yet another embodiment, the sweetened compositions comprise a Lo Han Guo sweetener that comprises substantially pure mogroside V, present in an amount above the sweetness recognition threshold concentration, and the sweetener taste modulator 4, present in an amount at or below the sweetness recognition threshold concentration. In yet another embodiment, the sweetened compositions comprise a Lo Han Guo sweetener that comprises substantially pure mogroside V, present in an amount above the sweetness recognition threshold concentration, and the sweetener taste modulator 5, present in an amount at or below the sweetness recognition threshold concentration. In yet other embodiments, the sweetened compositions comprise a Lo Han Guo sweetener that comprises substantially pure mogroside V, present in an amount above the sweetness recognition threshold concentration, and a mixture of sweetener taste modulators, present in an amount at or below sweetness recognition threshold concentrations, selected from the group consisting of compound 1, compound 2, compound 3, compound 4, compound 5 and combinations thereof.

In preferred embodiments, the at least one sweetener taste modulator, present in the sweetened composition an amount at or below the sweetness recognition threshold concentration, increases the sugar-like tasting quality of the sweetened composition. An increase in the sugar-like tasting quality can be determined by comparing the flavor profile, taste profile and/or temporal profile of the sweetened composition in the presence and absence of the at least one sweetener taste modulator.

In some embodiments, the sweetness intensity of the sweetened compositions in the presence of the at least one sweetener taste modulator, present in an amount at or below the sweetness recognition threshold concentration, increases by greater than 0.5%, such as about 1%, about 2%, about 3%, about 4% or about 5%, relative to the sweetness of the sweetened compositions in the absence of the at least one sweetener taste modulator, as measured by sucrose equivalence. For example, the sweetness intensity may increase by greater than about 10% or by greater than about 20% relative to the sweetness of a composition comprising the at least one natural sweetener without the at least one steviol glycoside sweetener, as measured by sucrose equivalence.

In other embodiments, the bitterness of sweetened compositions is decreased in the presence of the at least one sweetener taste modulator, present in an amount at or below the sweetness recognition threshold concentration, relative to the bitterness of corresponding sweetened compositions in the absence of the at least one sweetener taste modulator.

In other embodiments, the detected licorice taste of the sweetened compositions is decreased in the presence of the at least one sweetener taste modulator, present in the sweetened composition an amount at or below the sweetness recognition threshold concentration, relative to the detected licorice taste of corresponding sweetened compositions in the absence of the at least one sweetener taste modulator.

In other embodiments, the sweetness linger (aftertaste) of the sweetened compositions is decreased in the presence of the at least one sweetener taste modulator, present in the sweetened composition in an amount at or below the sweetness recognition threshold concentration, relative to the sweetness linger (aftertaste) of corresponding sweetened compositions in the absence of the at least one sweetener taste modulator.

In preferred embodiments, one or more attributes of the sugar-like taste qualities of the sweetened compositions is improved in the presence of the at least one sweetener taste modulator, present in the sweetened composition an amount at or below the sweetness recognition threshold concentration. For example, the bitterness, licorice taste and sweetness linger can be decreased in the presence of the at least one sweetener taste modulator, present in an amount at or below the sweetness recognition threshold concentration.

It is contemplated that the combination of at least one sweetener taste modulator and at least one natural sweetener may be carried out in any pH range that does not materially or adversely affect the taste of the sweetened composition or the sweetened composition. A non-limiting example of the pH range may be from about 1.8 to about 8. A further example includes a pH range from about 2 to about 5. The temperature of the composition may, for example, range from 4° C. to 25° C.

One of ordinary skill in the art may combine the at least one natural sweetener, for example at least two Stevia sweeteners or at least three Stevia sweeteners, and at least one sweetener taste modulator, for example at least two or at least three sweetener taste modulators, in any manner.

iv. Additional Ingredients

In addition to the natural sweetener, the present sweetened compositions may further comprise one or more additional sweeteners. The additional sweetener can be any type of sweetener, for example a caloric, non-natural, or synthetic sweetener.

For example, the at least one additional sweetener may be a caloric carbohydrate sweetener. Non-limiting examples of suitable caloric carbohydrate sweeteners include sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, ribose, isomerized liquid sugars such as high fructose corn/starch syrup (HFCS) (e.g., HFCS55, HFCS42, or HFCS90), coupling sugars, soybean oligosaccharides, glucose syrup, and mixtures thereof.

In other embodiments, the at least one additional sweetener is a sweetener selected from the group consisting of glucose, fructose, sucrose, and mixtures thereof.

In other embodiments, the at least one additional sweetener is a carbohydrate sweetener.

In yet other embodiments, the at least one additional sweetener is a synthetic sweetener. As used herein, the phrase “synthetic sweetener” refers to any composition which is not found naturally in nature and characteristically has a sweetness potency greater than sucrose, fructose, or glucose, yet have less calories. Non-limiting examples of synthetic high-potency sweeteners suitable for embodiments of this disclosure include sucralose, potassium acesulfame, aspartame, alitame, saccharin, neohesperidin dihydrochalcone, cyclamate, neotame, advantame, glucosylated steviol glycosides (GSGs) salts thereof, and the like.

In addition, those of ordinary skill in the art will appreciate that the sweetened composition can be customized to obtain the desired calorie content. For example, a low-caloric or non-caloric synthetic sweetener may be combined with a caloric sweetener and/or other caloric additives to produce a sweetener or sweetened composition with a preferred calorie content.

The term “polyol”, as used herein, refers to a molecule that contains more than one hydroxyl group. A polyol may be a diol, triol, or a tetraol which contains 2, 3, and 4 hydroxyl groups respectively. A polyol also may contain more than four hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group.

Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect the taste of the sweetened compositions.

In at least one embodiment, the sweetened compositions of the disclosure comprise at least one additional additive, such as a sweet taste improving composition, and/or a sweet taste improving additive.

For example, suitable sweet-taste improving compositions include, but are not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, flavonoids, alcohols, polymers, other sweet taste improving taste additives imparting such sugar-like taste quality, and combinations thereof.

As used herein, the phrase “sweet taste improving additive” means any material that imparts a more sugar-like temporal profile, sugar-like character, sugar-like sweet temporal profile or sugar-like flavor profile or any combinations of them to a synthetic sweetener. Suitable sweet taste improving additives useful in embodiments of this disclosure include amino acids and salts thereof, poly-amino acids and salts thereof, peptides, sugar acids and salts thereof, nucleotides and salts thereof, organic acids, inorganic acids, organic salts including organic acid salts and organic base salts, inorganic acid salts (e.g., sodium chloride, potassium chloride, magnesium chloride), acid salts (e.g., sodium citrate), bitter compounds, flavorants and flavoring ingredients, astringent compounds, polymers, proteins or protein hydrolysates, surfactants, emulsifiers, flavonoids, alcohols, and natural high-potency sweeteners.

Suitable sweet taste improving amino acid additives for use in embodiments of this disclosure include, but are not limited to, aspartic acid, arginine, glycine, glutamic acid, proline, threonine, theanine, cysteine, cystine, alanine, valine, tyrosine, leucine, isoleucine, asparagine, serine, lysine, histidine, ornithine, methionine, carnitine, aminobutyric acid (α-, β, or γ-isomers), glutamine, hydroxyproline, taurine, norvaline, sarcosine, and their salt forms such as sodium or potassium salts or acid salts. The sweet taste improving amino acid additives also may be in the D- or L-configuration and in the mono-, di-, or tri-form of the same or different amino acids. Additionally, the amino acids may be α-, β-, γ-, δ-, and ε-isomers if appropriate. Combinations of the foregoing amino acids and their corresponding salts (e.g., sodium, potassium, calcium, magnesium salts or other alkali or alkaline earth metal salts thereof, or acid salts) also are suitable sweet taste improving additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids. As used herein, amino acids also encompass both peptides and polypeptides (e.g., dipeptides, tripeptides, tetrapeptides, and pentapeptides) such as glutathione and L-alanyl-L-glutamine. Suitable sweet taste improving polyamino acid additives include poly-L-aspartic acid, poly-L-lysine (e.g., poly-L-α.-lysine or poly-L-ε-lysine), poly-L-ornithine (e.g., poly-L-α-ornithine or poly-L-ε-ornithine), poly-L-arginine, other polymeric forms of amino acids, and salt forms thereof (e.g., calcium, potassium, sodium, or magnesium salts such as L-glutamic acid mono sodium salt). The sweet taste improving poly-amino acid additives also may be in the D- or L-configuration. Additionally, the poly-amino acids may be α-, β-, γ-, δ-, and ε-isomers if appropriate. Combinations of the foregoing poly-amino acids and their corresponding salts (e.g., sodium, potassium, calcium, magnesium salts or other alkali or alkaline earth metal salts thereof or acid salts) also are suitable sweet taste improving additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). As used herein, poly-amino acids encompass both modified and unmodified poly-amino acids. For example, modified poly-amino acids include, but are not limited to poly-amino acids of various molecular weights (MW), such as poly-L-.alpha.-lysine with a MW of 1,500, MW of 6,000, MW of 25,200, MW of 63,000, MW of 83,000, or MW of 300,000.

Suitable sweet taste improving sugar acid additives include, for example, but are not limited to aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof

For example, suitable sweet taste improving nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

Suitable sweet taste improving organic acid additives include any compound which comprises a —COOH moiety. Suitable sweet taste improving organic acid additives, for example, include but are not limited to C2-C30 carboxylic acids, substituted hydroxyl C2-C30 carboxylic acids, benzoic acid, substituted benzoic acids (e.g., 2,4-dihydroxybenzoic acid), substituted cinnamic acids, hydroxyacids, substituted hydroxybenzoic acids, substituted cyclohexyl carboxylic acids, tannic acid, lactic acid, tartaric acid, citric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration.

For example, suitable sweet taste improving organic acid additive salts include, but are not limited to, sodium, calcium, potassium, and magnesium salts of all organic acids, such as salts of citric acid, malic acid, tartaric acid, fumaric acid, lactic acid (e.g., sodium lactate), alginic acid (e.g., sodium alginate), ascorbic acid (e.g., sodium ascorbate), benzoic acid (e.g., sodium benzoate or potassium benzoate), and adipic acid. The examples of the sweet taste improving organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfinyl, sulfamyl, carboxalkoxy, carboxamido, phosphonyl, phosphinyl, phosphoryl, phosphino, thioester, thioether, anhydride, oximino, hydrazino, carbamyl, phospho, phosphonato, and any other viable functional group provided the substituted organic acid additives function to improve the sweet taste of a synthetic sweetener.

For example, suitable sweet taste improving inorganic acid additives include but are not limited to phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

In at least one embodiment, the sweetened composition can be prepared by combining the at least one natural sweetener with at least one sweetener taste modulator prior to being added to an orally ingestible composition or a sweetenable composition to generate a sweetened composition. For example, the at least one natural sweetener may be in a pure, diluted, or concentrated form as a liquid (e.g., solution), solid (e.g., powder, chunk, pellet, grain, block, crystalline, or the like), suspension, gas state, or combinations thereof may be contacted with the at least one sweet taste improving composition which may be in a pure, diluted, or concentrated form as a liquid (e.g., solution), solid (e.g., powder, chunk, pellet, grain, block, crystalline, or the like), suspension, gas state, or combinations thereof and with the at least one sweetener taste modulator which may be in pure, diluted, or concentrated form as a liquid (e.g., solution), solid (e.g., powder, chunk, pellet grain, block, crystalline, or the like), suspension, gas state, or combinations thereof before all are contacted with an orally ingestible composition. In yet another embodiment, when there is more than one natural sweetener or more than one sweetener taste modulator, each component of the sweetened composition may be added simultaneously, in an alternating pattern, in a random pattern, or any other pattern.

Sweetened compositions of the present invention include, for example, food, beverage, pharmaceutical, tobacco, nutraceutical, oral hygienic/cosmetic products, and the like. Non-limiting examples of these products include non-carbonated and carbonated beverages such as colas, ginger ales, root beers, ciders, fruit-flavored soft drinks (e.g., citrus-flavored soft drinks such as lemon-lime or orange), powdered soft drinks, and the like; fruit juices originating in fruits or vegetables, fruit juices including squeezed juices or the like, fruit juices containing fruit particles, fruit beverages, fruit juice beverages, beverages containing fruit juices, beverages with fruit flavorings, vegetable juices, juices containing vegetables, and mixed juices containing fruits and vegetables; sport drinks, energy drinks, near water and the like drinks (e.g., water with natural or synthetic flavorants); tea type or favorite type beverages such as coffee, cocoa, black tea, green tea, oolong tea and the like; beverages containing milk components such as milk beverages, coffee containing milk components, cafe au lait, milk tea, fruit milk beverages, drinkable yogurt, lactic acid bacteria beverages or the like; dairy products; bakery products; desserts such as yogurt, jellies, drinkable jellies, puddings, Bavarian cream, blancmange, cakes, brownies, mousse and the like, sweetened food products eaten at tea time or following meals; frozen foods; cold confections, e.g. types of ice cream such as ice cream, ice milk, lacto-ice and the like (food products in which sweeteners and various other types of raw materials are added to milk products, and the resulting mixture is agitated and frozen), and ice confections such as sherbets, dessert ices and the like (food products in which various other types of raw materials are added to a sugary liquid, and the resulting mixture is agitated and frozen); ice cream; general confections, e.g., baked confections or steamed confections such as cakes, crackers, biscuits, buns with bean-jam filling and the like; rice cakes and snacks; table top products; general sugar confections such as chewing gum (e.g., including compositions which comprise a substantially water-insoluble, chewable gum base, such as chicle or substitutes thereof, including jetulong, guttakay rubber or certain comestible natural synthetic resins or waxes), hard candy, soft candy, mints, nougat candy, jelly beans and the like; sauces including fruit flavored sauces, chocolate sauces and the like; edible gels; cremes including butter cremes, flour pastes, whipped cream and the like; jams including strawberry jam, marmalade and the like; breads including sweet breads and the like or other starch products; spice; general condiments including seasoned soy sauce used on roasted meats, roast fowl, barbecued meat and the like, as well as tomato catsup, sauces, noodle broth and the like; processed agricultural products, livestock products or seafood; processed meat products such as sausage and the like; retort food products, pickles, preserves boiled in soy sauce, delicacies, side dishes; snacks such as potato chips, cookies, or the like; cereal products; drugs or quasi-drugs that are administered orally or used in the oral cavity (e.g., vitamins, cough syrups, cough drops, chewable medicine tablets, amino acids, bitter-tasting drug or pharmaceutical agents, acidulants or the like), wherein the drug may be in solid, liquid, gel, or gas form such as a pill, tablet, spray, capsule, syrup, drop, troche agent, powder, and the like; personal care products such as other oral compositions used in the oral cavity such as mouth freshening agents, gargling agents, mouth rinsing agents, toothpaste, tooth polish, dentifrices, mouth sprays, teeth-whitening agents and the like; dietary supplements; tobacco products including smoke and smokeless tobacco products such as snuff, cigarette, pipe and cigar tobacco, and all forms of tobacco such as shredded filler, leaf, stem, stalk, homogenized leaf cured, reconstituted binders and reconstituted tobacco from tobacco dust, fines or ether sources in sheet, pellet or other forms, tobacco substitutes formulated from non-tobacco materials, dip or chewing tobacco; animal feed; and nutraceutical products, which includes any food or part of a food that may provide medicinal or health benefits, including the prevention and treatment of disease (e.g., cardiovascular disease and high levels of cholesterol in the blood, diabetes, osteoporosis, inflammation, or autoimmune disorders).

In a preferred embodiment, a sweetened composition is a beverage comprising a natural sweetener, selected from a Stevia sweetener a Lo Han Guo sweetener or a combination thereof, and at least one sweetener taste modulator of the Formulae and compounds described above, wherein the at least one sweetener taste modulator is present in the sweetened composition in an amount at or below the sweetness recognition threshold concentration and the natural sweetener is present in the sweetened composition in an amount above the sweetness threshold recognition concentration. In preferred embodiments, the beverage also comprises erythritol.

In a preferred embodiment, the beverage is a low calorie or zero-calorie beverage. In another preferred embodiment, the beverage is a carbonated beverage. A non-limiting example of the pH range may be from about 1.8 to about 8. A further example includes a pH range from about 2 to about 5. The temperature of the composition may, for example, ranges from 4° C. to 25° C.

The natural sweetener and the at least one sweetener taste modulators described herein can be combined with any liquid matrix (a type of sweetenable composition) to formed a liquid sweetened composition. Liquid matrices include, but are not limited to water, phosphoric acid, phosphate buffer, citric acid, citrate buffer and carbon-treated water.

D. Methods for Improving Sugar-Like Taste Quality

Another aspect of the disclosure is a method of enhancing, or improving, the sugar-like taste quality of compositions comprising a natural Stevia or Lo Han Guo sweetener. Such methods comprise combining (i) a natural sweetener, selected from the group consisting of a Stevia sweetener, a Lo Han Guo sweetener or a combination thereof, and (ii) at least one sweetener taste modulator of the Formulae and compounds disclosed above, wherein natural sweetener is present in the sweetened composition an amount above the sweetness recognition threshold concentration and wherein the at least one sweetener taste modulator is present in the sweetened composition in an amount at or below the sweetness recognition threshold concentration.

In other embodiments, a method of enhancing, or improving, the sugar-like taste quality of a beverage comprising a natural sweetener. Such methods comprise combining (i) a natural sweetener, selected from the group consisting of a Stevia sweetener, a Lo Han Guo sweetener, or a combination thereof, and (ii) at least one sweetener taste modulator of the Formulae and compounds disclosed above, wherein natural sweetener is present in the sweetened composition an amount above the sweetness recognition threshold concentration and wherein the at least one sweetener taste modulator is present in the sweetened composition in an amount at or below the sweetness recognition threshold concentration

### EXAMPLES

### Example 1: Determination of Sweetness Threshold Recognition Concentration for Certain Steviol Glycosides

A sip (approximately 2-5 mL) of control sample, including but not limited to water, was tasted and swallowed by a trained taste tester. After allowing a 15-25 second interval to pass, a second sip of the control is tasted and swallowed. The taste properties of the control are determined and recorded by the trained taste tester. An unknown sample is then tasted and swallowed in the same manner, allowing a 15-25 second interval between the two sips. Preferably no more than ten additives are tested per day to avoid taste fatigue. Each sample was taken at least 1.5 hours following eating or drinking. The sweetness recognition thresholds concentration of 21 steviol glycosides were determined in this manner, and are shown in Table 1.

TABLE 1

| | Sweetness recognition |
|---|---|
| Compound | threshold Level (ppm) |
| Rebaudioside A (REB A) | 12.6 |
| Stevioside | 25 |
| Rebaudioside B (REB B) | 25 |
| Steviolbioside | 50 |
| 3 | 700 |
| 4 | 25 |
| 1 (max. level for solubility) | 500 |
| 2 | 35 |
| Dulcoside A | 50 |
| Steviol glucuronide | 85 |
| Rebaudioside C (REB C) | 100 |
| Rebaudioside F (REB F) | 25 |
| Rebaudioside D (REB D) | 25 |
| 5 | 250 |
| Mogroside V | 20 |
| Rubusoside | 50 |

### Example 2: Determination of Sugar-Like Taste Quality Enhancement of Stevia Sweeteners with Steviol Glycosides

A steviol glycoside is added in an amount at or below sweetness recognition threshold concentration to a solution of water and a Stevia sweetener. The solution is maintained at room temperature. Each sample is taste tested by a trained individual, as described in Example 1, in duplicate. Preferably no more than ten steviol glycosides are tested per day to avoid taste fatigue. Each sample was taken at least 1.5 hours following eating or drinking

The Stevia sweeteners used in this study were 97% pure rebaudioside A, JSS, and rebaudioside D.

The steviol glycosides were used in at or below sweetness recognition threshold concentrations. The main stevia sweetener samples had a fixed 5% sucrose equivalence. The results of the taste tests are show in Table 2.

TABLE 2

| | Stevia Sweetener | | |
|---|---|---|---|
| | REBA | JSS | REBD |
| Steviol Glycoside Additive | (303 ppm) | (380 ppm) | (303 ppm) |
| REB A | N/A | N | N |
| REB B | N | N | N |
| Stevioside | N | N/A | N |
| Steviolbioside | N | N | N |
| 3 | +, −B, −SL, OF | −B, OF | +, −SL, OF |
| 4 | N | N | N |
| 1 | ++, ASLC, +S, −B | ++, ASLC, +S, −B | ++, ASLC, +S, −B |
| 2 | ++, −SL, −B | DB | N(+), W |
| DAQ 5 | −B, DB | DB, WSQ | −S, W |
| Dulcoside A | N | N | N |
| Steviol glucuronide | N | −B | N |
| REB C | N | N | N |
| REB F | N | N | N |
| REB D | N | N | N/A |
| 5 | +, −B, W | N | N |
| Mogroside V | N | N | ~+S |
| Rubusoside | N(+) | N | N |

Key:
N/A: not applicable;
N: no difference in presence or absence of steviol glycoside additive;
N(+): same as “N” but slightly more;
~+S: Slightly more detected sweetness intensity (~0.5% Sucrose Equivalence);
−S: Less Sweet
−SL: Less Sweetness Lingering
−B: Less Bitterness
+: More Sugar-like taste quality;
++: Significantly more Sugar-like taste quality;
ASLC = Authentic Sugar-Like Characteristic taste (similar to melting a sugar cane cube on top surface of tongue, same as sugar-like taste quality);
W: Slight watery note;
DB: Different pattern of bitterness;
OF: Slightly chemical note;
WSQ: Worst overall sweet tasting quality

Results

Six of 21 steviol glycosides at their at or below sweetness recognition threshold concentrations were found to modulate the rebaudioside A, JSS and/or rebaudioside D to exhibit more sugar-like tasting qualities.

The largest overall enhancement effect was found with 1, a known acid degradation compound of rebaudioside A. At 500 ppm, this compound significantly enhanced all three control 5% SE Stevia sweeteners to a much superior sugar-like tasting quality with no bitterness, sweet lingering or off-taste note and a slightly sweeter profile by ca. 1% SE. In addition, it produced an authentic sugar-like character and tasting quality in all three Stevia sweeteners that were evaluated. A similar, but smaller positive sugar-like taste quality enhancement effect was also observed in 2 and 3 and 5, mostly in 5% SE rebaudioside A.

Despite there being no sweetness and off-taste notes (all additives were found to have a chemical-like note at above threshold levels) in their blank additive solutions (e.g. in the absence of the stevia sweetener sweeteners), 3 at 700 ppm does provide a positive modulation of all Stevia sweeteners, but it was also found to contain weak chemical-like note.

Compound 5, known as an impurity of rebaudioside A, was found at 250 ppm to improve the sugar-like taste quality of rebaudioside A. The steviol glucuronide at 85 ppm was only found to contain less bitterness in 5% SE JSS.

1.-39. (canceled)

40. A sweetened composition comprising (i) rebaudioside A with a purity of at least about 90% in a steviol glycoside mixture, wherein the rebaudioside A is present in an amount above its sweetness recognition threshold concentration and (ii) at least one sweetener taste modulator in an amount at or below the sweetener taste modulator's sweetness recognition threshold concentration, wherein the sweetener taste modulator is selected from the group consisting of:

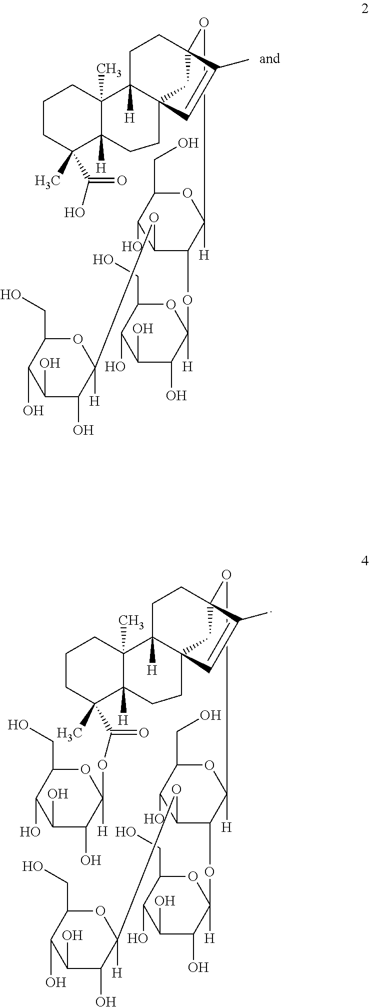

41. The sweetened composition of claim 40, wherein the at least one sweetener taste modulator increases the sugar-like taste quality of the sweetened composition compared to the sweetened composition in the absence of the at least one sweetener taste modulator.

42. The sweetened composition claim 40, wherein the sweetener taste modulator decreases the bitterness of the sweetened composition compared to the sweetened composition in the absence of the at least one sweetener taste modulator.

43. The sweetened composition of claim 40, wherein the sweetener taste modulator decreases the licorice taste of the sweetened composition compared to the sweetened composition in the absence of the at least one sweetener taste modulator.

44. The sweetened composition of claim 40, wherein the sweetener taste modulator decreases the sweetness linger of the sweetened composition compared to the sweetened composition in the absence of the at least one sweetener taste modulator.

45. The sweetened composition of claim 40, wherein the at least one sweetener taste modulator improves one or more attributes of the sugar-like taste quality of the sweetened composition compared the sweetened composition in the absence of the at least one sweetener taste modulator, wherein the attributes are selected from the group consisting of bitterness, licorice taste and sweetness linger.

46. The sweetened composition of claim 40, wherein the sweetened composition is selected from the group consisting of a beverage, food pharmaceutical, nutraceutical, oral hygienic product and cosmetic product.

47. The sweetened composition of claim 46, wherein the sweetened composition is a beverage.

48. The sweetened composition of claim 47, wherein the beverage is selected from the group consisting of a carbonated beverage and non-carbonated beverage.

49. The sweetened composition of claim 47, wherein the beverage is selected from the group consisting of cola, ginger ale, root beer, cider, fruit-flavored soft drink, powdered soft drink, fruit juice, fruit beverage, vegetable juice, sports drink, energy drink, near water, tea, coffee, cocoa and beverage containing milk component.

50. The sweetened composition of claim 47, wherein the beverage is a zero-calorie beverage.

51. The sweetened composition of claim 47, wherein the pH of the beverage ranges from about 1.8 to about 8.

52. The sweetened composition of claim 51, wherein the pH of the beverage ranges from about 2 to about 5.

53. The sweetened composition of claim 47, wherein the temperature of the beverage ranges from about 4° C. to about 25° C.
